(19) United States
(12) Patent Application Publication
(10) Pub. No.: US 2014/0267964 A1
(43) Pub. Date: Sep. 18, 2014

(54) LIQUID CRYSTAL DRIVING METHOD AND LIQUID CRYSTAL DISPLAY DEVICE

(71) Applicant: Sharp Kabushiki Kaisha, Osaka-shi, Osaka (JP)

(72) Inventors: Yuichi Iyama, Osaka-shi (JP); Takatomo Yoshioka, Osaka-shi (JP); Kazuhiko Tsuda, Osaka-shi (JP)

(73) Assignee: Sharp Kabushiki Kaisha, Osaka-shi, Osaka (JP)

(21) Appl. No.: 14/350,962

(22) PCT Filed: Oct. 5, 2012
(86) PCT No.: PCT/JP2012/075893

§ 371 Date: Apr. 10, 2014

(30) Foreign Application Priority Data
Oct. 14, 2011 (JP) 2011-227410

(51) Int. Cl. G02F 1/133

(52) U.S. Cl. CPC G02F 1/13306
USPC 349/33

(57) ABSTRACT

Provided is a liquid crystal driving method and a liquid crystal display device that provide a sufficiently high response speed and a sufficiently excellent contrast ratio by reducing distortion of the electric field and sufficiently reducing transmittance during black display. The liquid crystal driving method of the present invention is a liquid crystal driving method of driving a liquid crystal using electrodes at a liquid crystal layer side and an electrode opposite to the liquid crystal layer side disposed in one of upper and lower substrates, the liquid crystal driving method including: performing a driving operation in which the electrode opposite to the liquid crystal layer side has a higher absolute value of an applied voltage than that of the electrodes at the liquid crystal layer side to align an alignment direction of the liquid crystal in a vertical direction or a horizontal direction to main faces of the substrates.

### TECHNICAL FIELD

The present invention relates to a liquid crystal driving method and a liquid crystal display device. The present invention specifically relates to a liquid crystal driving method and a liquid crystal display device which are particularly suitable for a field sequential driving method and the like.

### BACKGROUND ART

A liquid crystal driving method is a method of generating an electric field between electrodes to drive liquid crystal molecules in a liquid crystal layer disposed between a pair of substrates, and thereby the method can change optical characteristics of the liquid crystal layer and can control light transmittance/non-transmittance, that is, can change display (an ON state)/non-display (an OFF state).

Such a liquid crystal driving provides various forms of liquid crystal display devices in various applications by using advantages such as a thin profile, a light weight, and a low power consumption. Various driving methods are devised and put to practical uses in displays for devices including personal computers, televisions, onboard devices such as automotive navigation systems, and personal digital assistants such as mobile phones, and display devices capable of displaying a stereoscopic image.

For the liquid crystal display devices, various display methods (display modes) are developed depending on characteristics of liquid crystals, different electrode arrangements, and different substrate designs. Broadly classified, examples of the display modes of widely used current liquid crystal display devices include: a vertical alignment (VA) mode in which liquid crystal molecules having negative anisotropy of dielectric constant are aligned vertically to the substrate surfaces; an in-plane switching (IPS) mode and a fringe field switching (FFS) mode in which liquid crystal molecules having positive or negative anisotropy of dielectric constant are aligned horizontally to the substrate surfaces and a transverse electric field is applied to the liquid crystal layer. In these display modes, several liquid crystal driving methods are suggested.

One document discloses, as a FFS-driving liquid crystal display device, a thin-film-transistor liquid crystal display having a high response speed and a wide viewing angle. The device includes a first substrate having a first common electrode layer; a second substrate having a pixel electrode layer and a second common electrode layer; a liquid crystal disposed between the first substrate and the second substrate; and a means for generating an electric field between the first common electrode layer of the first substrate and both of the pixel electrode layer and the second common electrode layer of the second substrate so as to provide a high-speed response to a fast input-data-transfer rate and a wide viewing angle for a viewer (for example, see Patent Literature 1).

Another document discloses, as a liquid crystal device with multiple electrodes applying a transverse electric field, a liquid crystal device including a pair of substrates opposite to each other; a liquid crystal layer which includes a liquid crystal having a positive anisotropy of dielectric constant and which is interposed between the substrates; electrodes which are provided to the respective first and second substrates constituting the pair of substrates, facing each other with the liquid crystal layer therebetween, and which apply a vertical electric field to the liquid crystal layer; and multiple electrodes for applying a transverse electric field to the liquid crystal layer disposed in the second substrate (for example, see Patent Literature 2).

### CITATION LIST

### Patent Literature

Patent Literature 1: JP 2006-523850 T
Patent Literature 2: JP 2002-365657 A

### SUMMARY OF INVENTION

### Technical Problem

A liquid crystal driving method of driving a liquid crystal using an upper electrode and a lower electrode disposed in one of upper and lower substrates enables high-speed response. For example, a FFS-driving liquid crystal display device enables high-speed response by rotating the liquid crystal molecules by electric fields in both rising and falling. The rising (where the display state changes from a dark state (black display) to a bright state (white display)) utilizes a fringe electric field (FFS driving) generated between an upper slit electrode and a lower planar electrode of the lower substrate. The falling (where the display state changes from a bright state (white display) to a dark state (black display)) utilizes a vertical electric field generated by the electric potential difference between the substrates.

A vertical-alignment liquid crystal display device including a three-layered electrode structure (a counter electrode, an upper electrode, and a lower electrode) enables high-speed response by rotating the liquid crystal molecules by electric fields in both rising and falling; here, the rising utilizes a transverse electric field applied between upper comb-shaped electrodes in the lower substrate, and the falling utilizes a vertical electric field generated by the electric potential difference between the upper and lower substrates. In addition, high transmittance during white display can be sufficiently achieved.

FIG. 21 is a schematic cross-sectional view showing a liquid crystal display device in the presence of a vertical electric field according to a liquid crystal driving method using the three-layered electrodes. As shown in FIG. 21, distortion of the electric field (dot line) in a space surrounded by alternate long and short dash lines causes insufficient vertical alignment of the liquid crystal, even when black display is performed by applying the vertical electric field. This increases transmittance during the black display and thus a contrast ratio (CR) is reduced.

In order to solve the above problem, the technique described in Japanese Patent Application No. 2011-142351 provides an initialization process. FIG. 23 is a schematic cross-sectional view showing a liquid crystal display device when an initialization process is performed in a liquid crystal driving method. In the above technique, the initialization process is added (voltages of all electrodes are set to 0 V in one time) in order to reduce black transmittance. The method of adding the initialization process as mentioned above aligns the liquid crystal molecules in a vertical direction during black display and improves the contrast ratio. However, this method drives two times in one frame, and thus a driving method becomes complex.

The present invention is devised in view of the above situation, and aims to provide an easy liquid crystal driving method and a liquid crystal display device that can have an excellent contrast ratio by providing sufficiently excellent transmittance and sufficiently reducing the transmittance during black display in a liquid crystal driving method of driving a liquid crystal using an upper electrode and a lower electrode disposed in one of the upper and lower substrates that enables high-speed response.

### Solution to Problem

The present inventors have performed studies on a liquid crystal driving method in which improved high-speed response, high transmittance, and contrast are achieved in a vertical-alignment liquid crystal display panel and liquid crystal display device. As a result, the present inventors have found that, in a conventional liquid crystal driving method, a contrast ratio is reduced by setting the same electric potential to the upper electrode and the lower electrode in the lower substrate, that is, the contrast ratio is reduced because the liquid crystal is not completely aligned in a vertical direction in the case that the upper electrode and the lower electrode have the same electric potential when, for example, the liquid crystal is driven by a vertical electric field in the falling.

Usually, electric leakage is prevented by disposing a dielectric film between the upper electrode and the lower electrode. However, since the dielectric film also acts as a condenser, voltage applied to the lower electrode is also applied to both of a liquid crystal layer and a dielectric film layer and the voltage applied to the liquid crystal layer is substantially decreased. Thus, when the voltages applied to the upper electrode and the lower electrode are equal, the voltage applied to the liquid crystal layer becomes different on a line (on a linear electrode) and in a space (between electrodes), resulting in a distorted electric field. This distortion causes slightly oblique alignment of the liquid crystal from the vertical direction and the alignment increases black transmittance (transmittance at the time of black display (gray scale value of 0)). This reduces the contrast ratio. In other words, as mentioned above regarding FIG. 21, when the voltages of the upper electrode and the lower electrode are equal, the electric field in the space is distorted, and the liquid crystal in the space is tilted and is not aligned in the vertical direction.

FIG. 22 is a schematic cross-sectional view showing a liquid crystal display device in the presence of a vertical electric field according to a liquid crystal driving method of the present invention.

The present inventors have focused on adequate control of voltages applied to the upper electrode and the lower electrode, for example, in order to reduce the distortion of the electric field during black display. As a result, the present inventors have found that a voltage applied to the lower electrode 13 is set larger (slightly increased) than a voltage applied to the upper electrode (for example, comb-shaped electrodes 17, 19). This allows the distortion of the electric field (dot line) to be eliminated, the liquid crystal to be aligned in a vertical direction, and the contrast ratio to be improved to almost the same extent as in the case where no voltage is applied because the voltage applied to the liquid crystal layer becomes closer to being equipotential on a line (a region overlapping the linear electrode in the plan view of the main faces of the substrates; also referred to as a line part) and in a space (a region overlapping the space between the electrodes in a plan view of the main faces of the substrates; also referred to as a space part). In other words, as shown in FIG. 22, the present inventors have found that the distortion of the electric field (dot line) is reduced by an easy method in which slightly higher electric field is applied to the electrode opposite to the liquid crystal layer and the liquid crystal is aligned in a vertical direction when the positive-type liquid crystal (liquid crystal having positive anisotropy of dielectric constant) is used, while the present inventors have also found that the liquid crystal is aligned in a horizontal direction in a display state when the negative-type liquid crystal (liquid crystal having negative anisotropy of dielectric constant) is used. Both cases can improve the contrast ratio, and the present inventors have arrived at the solutions of the above problems and have completed the present invention.

Particularly, the present invention is preferably applied to a liquid crystal driving method for a vertical-alignment liquid crystal display device in which two pairs of electrodes drive liquid crystal, the liquid crystal display device including a three-layered electrode structure (upper electrodes of the lower substrate are comb-shaped electrodes) using a positive-type liquid crystal (liquid crystal having positive anisotropy of dielectric constant). The method provides a high response speed by rotating the liquid crystal molecules by electric fields in both the rising and the falling; here, the rising utilizes a transverse electric field generated by the electric potential difference between the comb-shaped electrodes, and the falling utilizes a vertical electric field generated by the electric potential difference between the substrates. The method also provides a high transmittance by a transverse electric field of comb driving.

The present invention can further solve a markedly poor response speed in some applications, and can provide an excellent transmittance and contrast ratio as well as extremely excellent response speed.

In other words, the present invention is a liquid crystal driving method of driving a liquid crystal using electrodes at a liquid crystal layer side and an electrode opposite to the liquid crystal layer side disposed in one of upper and lower substrates, the liquid crystal driving method including: performing a driving operation in which the electrode opposite to the liquid crystal layer side has a higher absolute value of an applied voltage than that of the electrodes at the liquid crystal layer side to align an alignment direction of the liquid crystal in a vertical direction or a horizontal direction to main faces of the substrates.

As mentioned above, aligning the alignment direction of, for example, a liquid crystal having a positive anisotropy of dielectric constant can sufficiently reduce a transmittance in a non-display (black display) state when the liquid crystal is returned to an initial state (liquid crystal is vertically aligned to the main faces of the substrates) during the driving operation. In a liquid crystal having a negative anisotropy of dielectric constant, a transmittance in a display (white display) state can be sufficiently improved when the liquid crystal is horizontally aligned to be the display (white display) state during the driving operation. In either case, a contrast ratio improvement effect in the present invention can be exerted.

The phrase “performing a driving operation in which the electrode opposite to the liquid crystal layer side has a higher absolute value of an applied voltage than that of the electrodes at the liquid crystal layer side to align an alignment direction of the liquid crystal” herein means that the alignment direction of the liquid crystal in a display region can be substantially aligned in the vertical direction or the horizontal direction, and thereby the contrast ratio improvement effect may be exerted.

The liquid crystal driving method of the present invention also usually includes a method for drive in which the alignment direction of the liquid crystal is changed to return to the initial state. The phrase “drive in which the alignment direction of the liquid crystal is changed to return to the initial state” herein includes, for example, a drive in which the alignment direction of the liquid crystal is changed to be a display state, and thereafter the alignment direction of the liquid crystal is returned to the initial state to be a non-display state. Particularly, the present invention can be preferably applied to a liquid crystal driving method in which the alignment direction of the liquid crystal is returned to the initial state by the electric potential difference between the upper and lower substrates. The liquid crystal is usually a liquid crystal in the liquid crystal layer interposed between the upper and lower substrates. The phrase “return to the initial state” herein means that the liquid crystal is changed so as to align in a vertical direction to the main faces of the substrates in the liquid crystal having the positive anisotropy of dielectric constant.

In the liquid crystal having the positive anisotropy of dielectric constant, returning the liquid crystal molecules to the initial alignment can sufficiently reduce the transmittance, which slightly rises when the voltage between the upper electrode and the lower electrode are equal, into an initial black state by the driving operation in which the electrode opposite to the liquid crystal layer side has a higher absolute value of an applied voltage than that of the electrode at the liquid crystal layer side. In the liquid crystal having the negative anisotropy of dielectric constant, the transmittance during the display can be improved. Thus, the contrast ratio can be sufficiently improved in either liquid crystal. The driving operation may be an operation in which the electrode opposite to the liquid crystal layer side has a higher absolute value of an applied voltage than that of the electrode at the liquid crystal layer side. The liquid crystal driving method of the present invention is preferably a method which performs a driving operation so that a black brightness (brightness during black display) is lower than a black brightness when the same electric field is applied (voltages applied to an upper electrode and a lower electrode are the same) in the case where the liquid crystal having the positive anisotropy of dielectric constant is used.

A voltage applied to the lower electrode may be higher than a voltage applied to the upper electrode in the liquid crystal driving method of the present invention except that a driving operation in which the alignment direction of the liquid crystal is aligned in a vertical direction or a horizontal direction to the main faces of the substrates is performed.

The liquid crystal driving method of the present invention is preferably a method of driving a liquid crystal using two pairs of electrodes. When a pair of electrodes are determined as a first electrode pair and a pair of electrodes different from the first electrode pair are determined as a second electrode pair, the method including the drive in which the alignment direction of the liquid crystal is changed to return to the initial state preferably performs a driving operation that generates the electric potential difference between the electrodes of the first electrode pair and a driving operation that generates the electric potential difference between the electrodes of the second electrode pair.

The phrase “generates the electric potential difference between the first electrode pair” herein may be at least an operation that generates the electric potential difference between the electrodes of the first electrode pair and an operation in which the alignment of the liquid crystal is more controlled by an electric field between the electrodes of the first electrode pair than an electric field between the electrodes of the second electrode pair. The phrase “generates the electric potential difference between the second electrode pair” herein may be at least an operation that generates the electric potential difference between the electrodes of the second electrode pair and an operation in which the alignment of the liquid crystal is more controlled by an electric field between the electrodes of the second electrode pair than an electric field between the electrodes of the first electrode pair. At least two pairs of electrodes disposed in the upper and lower substrates herein means that at least two pairs of electrodes disposed in at least one of the upper and lower substrates.

The driving operation that generates the electric potential difference between the electrodes of the first electrode pair may be, for example, a driving operation in which the electrodes at the liquid crystal layer side disposed in one of the upper and lower substrates are a pair of comb-shaped electrodes and the electric potential difference is generated between the pair of comb-shaped electrodes, or a driving operation in which the electrode at the liquid crystal layer side disposed in one of the upper and lower substrates is an electrode including slit (hereinafter, referred to as a “slit electrode”) and the electric potential difference is generated between the slit electrode and the electrode opposite to the liquid crystal layer side.

In other words, a preferable mode of the present invention is that the electrodes at the liquid crystal layer side are the pair of comb-shaped electrodes. More preferably, the pair of comb-shaped electrodes are allowed to have different electric potentials at a threshold voltage or higher. Also, a preferable mode of the present invention is that the electrode at the liquid crystal layer side is the electrode including a slit.

The driving operation that generates the electric potential difference between the electrodes of the second electrode pair may include, for example, a driving operation in which the electric potential difference is generated between the electrode opposite to the liquid crystal layer side disposed in the one of the upper and lower substrates and an electrode disposed in the other of the upper and lower substrates. One of the electrodes of the first electrode pair and one of the electrodes of the second electrode pair may be the same electrode.

The present invention also is a liquid crystal driving method of driving a liquid crystal using electrodes at a liquid crystal layer side and an electrode opposite to the liquid crystal layer side disposed in one of upper and lower substrates, wherein the electrodes at the liquid crystal layer side are a pair of comb-shaped electrodes that are allowed to have different electric potentials at a threshold voltage or higher, and the liquid crystal driving method including: performing a driving operation in which one of the pair of the comb-shaped electrodes has a higher absolute value of an applied voltage than that of the other of the pair of the comb-shaped electrodes to align an alignment direction of the liquid crystal in a vertical direction or a horizontal direction to main faces of the substrates.

As mentioned above, aligning the alignment direction of a liquid crystal having a positive anisotropy of dielectric constant can also sufficiently reduce a transmittance in a non-display state when the liquid crystal is returned to an initial state (liquid crystal is vertically aligned to the main faces of the substrates) during the driving operation. In a liquid crystal having a negative anisotropy of dielectric constant, a transmittance in a display state can be sufficiently improved when the liquid crystal is horizontally aligned to be the display state during the driving operation. In either case, a contrast ratio improvement effect in the present invention can be exerted.

The phrase “performing a driving operation in which one of the pair of the comb-shaped electrodes has a higher absolute value of an applied voltage than that of the other of the pair of the comb-shaped electrodes to align an alignment direction of the liquid crystal” herein means that the alignment direction of the liquid crystal in a display region can be substantially aligned in the vertical direction or the horizontal direction and thereby the contrast ratio improvement effect can be exerted.

Even such a liquid crystal driving method sufficiently provides high-speed response and sufficiently reduces transmittance during black display by reducing the distortion of the electric field. This provides a sufficiently excellent contrast ratio. When a slit is not provided in the electrode opposite to the liquid crystal layer side, for example, reduction in voltage of only one side of the comb-shaped electrodes eliminates distortion of the electric field around the electrode. This can improve the contrast ratio.

In the liquid crystal driving method of the present invention mentioned above, the electrode opposite to the liquid crystal layer side is more preferably an electrode including a slit.

As mentioned above, high transmittance can be achieved during white display by providing the slit in the electrode opposite to the liquid crystal layer side. As mentioned later, however, the contrast ratio is not sufficiently improved by insufficient reduction in transmittance during black display. This causes a significant problem. However, application of configuration of the present invention can sufficiently solve the problem, which is more preferable.

It is preferable that the one of the pair of the comb-shaped electrodes does not overlap the electrode including the slit or overlaps apart of the electrode including the slit in a plan view of the main faces of the substrates; the other of the pair of the comb-shaped electrodes overlaps at least a part of the electrode including the slit in a plan view of the main faces of the substrates, an overlapped region of the one of the pair of the comb-shaped electrodes and the electrode including the slit is smaller than an overlapped region of the other of the pair of the comb-shaped electrodes and the electrode including the slit, and the liquid crystal driving method of the present invention includes: performing a driving operation in which the one of the pair of the comb-shaped electrodes has a higher absolute value of an applied voltage than that of the other of the pair of the comb-shaped electrodes to align the alignment direction of the liquid crystal in a vertical direction or a horizontal direction to the main faces of the substrates. This also makes it possible to improve the contrast ratio by, for example, reducing the distortion of the electric field during black display.

The liquid crystal driving method preferably includes performing the driving operation mentioned above to align the alignment direction of the liquid crystal in a vertical direction to the main faces of the substrates when the electric potential difference is generated between electrodes each disposed in the upper and lower substrates.

The driving operation changes to align a liquid crystal in a vertical direction to the main faces of the substrates when the liquid crystal is constituted by liquid crystal molecules having positive anisotropy of dielectric constant. The phrase “change to align a liquid crystal in a vertical direction to the main faces of the substrates” herein may at least satisfies the state regarded as changing the liquid crystal to be aligned substantially in the vertical direction to the main faces of the substrates in the technical field of the present invention.

The liquid crystal driving method preferably includes performing the above driving operation when an electric potential difference is generated between the electrode opposite to the liquid crystal layer side disposed in the one of the upper and lower substrates and an electrode disposed in the other of the upper and lower substrates.

The other of the upper and lower substrates preferably includes a dielectric layer. A thickness of the dielectric layer d_{oc} is preferably 3.5 μm or less. More preferably, the thickness is 2 μm or less. The lower limit thereof is preferably 1 μm or more.

The first electrode pair is preferably, for example, a pair of comb-shaped electrodes, and more preferably two comb-shaped electrodes are disposed opposite to each other in a plan view of the main faces of the substrates. These comb-shaped electrodes suitably generate a transverse electric field therebetween. With a liquid crystal layer including liquid crystal molecules having positive anisotropy of dielectric constant, the response performance and the transmittance are excellent in rising. With a liquid crystal layer including liquid crystal molecules having negative anisotropy of dielectric constant, the liquid crystal molecules are rotated by a transverse electric field to provide a high response speed in falling. The pair of comb-shaped electrodes preferably satisfies that the teeth portions are along each other in a plan view of the main faces of the substrates. Particularly preferably, the teeth portions of the pair of comb-shaped electrodes are substantially parallel with each other, in other words, each of the comb-shaped electrodes includes multiple substantially parallel slits. Usually, one comb-shaped electrode includes two or more teeth portions.

The second electrode pair is preferably capable of providing the electric potential difference between the substrates. This generates a vertical electric field by the electric potential difference between the substrates in falling with a liquid crystal layer including liquid crystal molecules having positive anisotropy of dielectric constant and in rising with a liquid crystal layer including liquid crystal molecules having negative anisotropy of dielectric constant, thereby rotating the liquid crystal molecules by the electric field to provide a high response speed. For example, in the falling, an electric field generated between the upper and lower substrates rotates the liquid crystal molecules in the liquid crystal layer in the vertical direction to the main faces of the substrates, thereby providing a high response speed. Particularly preferably, the first electrode pair is a pair of comb-shaped electrodes disposed in one of the upper and lower substrates and the second electrode pair is a pair of counter electrodes disposed in the respective upper and lower substrates.

The electrode disposed in the other of the upper and lower substrates is preferably planar. The electrode opposite to the liquid crystal layer side disposed in the one of the upper and lower substrates is preferably planar.

This generates a vertical electric field more suitably. The term “planar electrode” herein includes a mode in which multiple electrode portions of multiple pixels are electrically connected. Preferable examples of such a mode include a mode in which electrode portions of all the pixels are electrically connected and a mode in which electrode portions in a same pixel line are electrically connected. The term “planar” herein may at least satisfies the state regarded as having a planar shape in the technical field of the present invention, and may include an alignment-controlling structure such as a rib or a slit in a certain region or may include such an alignment-controlling structure at the center portion of a pixel in a plan view of the main faces of the substrates. Still, preferably, the planar electrode includes substantially no alignment-controlling structure. A particularly preferable mode for suitable application of a transverse electric field and a vertical electric field is applied such that the electrodes (upper electrodes) at the liquid crystal layer side constitute the first electrode pair and the electrode (lower electrode) opposite to the liquid crystal layer side constitutes one of the second electrode pair. For example, one of the second electrode pair may be disposed on the layer (the layer in the second substrate opposite to the liquid crystal layer) below the first electrode pair with an insulating layer interposed therebetween. The one of the second electrode pair may be independent in each pixel unit, may be electrically connected among all pixels, or may be electrically connected in the same pixel line. The one of the second electrode pair is preferably planar at least at the portion overlapping the other of the second electrode pair in a plan view of the main faces of the substrates.

The pair of the comb-shaped electrodes according to the liquid crystal driving method of the present invention may be disposed in the same layer or may be disposed in different layers as long as it provides the effects of the present invention. The pair of the comb-shaped electrodes are preferably disposed in the same layer. The phrase “the pair of the comb-shaped electrodes are disposed in the same layer” herein means that the comb-shaped electrodes are in contact with the same component (e.g. insulating layer, liquid crystal layer) on the liquid crystal layer side and/or the side opposite to the liquid crystal layer side, respectively.

The liquid crystal preferably includes liquid crystal molecules which are aligned in the vertical direction to the main faces of the substrates when no voltage is applied. The phrase “aligned in the vertical direction to the main faces of the substrates” and its derivative forms herein at least satisfy the state regarded as being aligned in the vertical direction to the main faces of the substrates in the technical field of the present invention, including a mode of alignment in the substantially vertical direction. The liquid crystal is preferably substantially constituted by liquid crystal molecules aligned in the vertical direction to the main faces of the substrates at a voltage less than a threshold voltage. The phrase “when no voltage is applied” and its derivative forms herein at least satisfy the state regarded as substantially no voltage application in the technical field of the present invention. Such a vertical alignment liquid crystal is advantageous to provide characteristics such as a wide viewing angle and a high contrast ratio, and its application range is widened.

The first electrode pair preferably has different electric potentials at a threshold voltage or higher. This means a voltage value that provides a transmittance of 5% with the transmittance in the bright state defined as 100%, for example. The phrase “have different electric potentials at a threshold voltage or higher” herein at least means that a driving operation that generates different electric potentials at a threshold voltage or higher can be implemented. This makes it possible to suitably control the electric field applied to the liquid crystal layer. The upper limit of each of the different electric potentials is preferably 20 V, for example. Examples of a structure for providing different electric potentials include a structure in which one of the electrodes of the first electrode pair is driven by a certain TFT while the other electrode is driven by another TFT or the other electrode communicates with the electrode disposed below the other electrode. This structure makes it possible to provide different electric potentials of the first electrode pair. The width of each tooth portion of the pair of the comb-shaped electrodes is preferably, for example, 2 μm or greater when the first electrode pair is the pair of the comb-shaped electrodes. The gap (also referred to as the space herein) between teeth portions is preferably 2 μm to 7 μm, for example.

The liquid crystal is preferably a liquid crystal that contain a component horizontally aligned to the main faces of the substrates by setting the electric potential difference of the first electrode pair to a threshold voltage or higher. The phrase “aligned in the horizontal direction” and its derivative forms herein at least satisfy the state regarded as being aligned in the horizontal direction in the technical field of the present invention. This enables high-speed response and is capable of improving transmittance when the liquid crystal includes liquid crystal molecules having positive anisotropy of dielectric constant (positive-type liquid crystal molecules). The liquid crystal is preferably substantially constituted by liquid crystal molecules aligned in the horizontal direction to the main faces of the substrates at a threshold voltage or higher.

The liquid crystal preferably includes liquid crystal molecules having positive anisotropy of dielectric constant (positive-type liquid crystal molecules). The liquid crystal molecules having positive anisotropy of dielectric constant are aligned in a certain direction when an electric field is applied. The alignment thereof is easily controlled and such molecules provide a higher response speed. The liquid crystal layer may also preferably include liquid crystal molecules having negative anisotropy of dielectric constant (negative-type liquid crystal molecules). This further improves the transmittance. From the viewpoint of a high response speed, the liquid crystal molecules are preferably substantially constituted by liquid crystal molecules having positive anisotropy of dielectric constant. From the viewpoint of transmittance, the liquid crystal molecules are preferably substantially constituted by liquid crystal molecules having negative anisotropy of dielectric constant.

The driving operation according to the present invention provides white display when the liquid crystal layer includes liquid crystal molecules having negative anisotropy of dielectric constant. Application of the same electric field to the upper and lower electrodes generates voltage distortion. This causes distortion of the electric field around edges of the upper electrodes, and thereby changes an azimuth of the liquid crystal. Application of the driving operation according to the present invention in order to perform the driving operation in which the electrode opposite to the liquid crystal layer side has the higher absolute value of an applied voltage than that of the electrode at the liquid crystal layer side eliminates distortion of the electric field and easily causes alignment of the entire liquid crystal in the same direction. This exerts the effects of improving the transmittance.

At least one of the upper and lower substrates usually includes an alignment film on the liquid crystal layer side. The alignment film is preferably a vertical alignment film. Examples of the alignment film include alignment films formed from organic material or inorganic material, photo-alignment films formed from photoactive material, and alignment films subjected to alignment treatment such as rubbing. The alignment film may be an alignment film without any alignment treatment such as rubbing. Alignment films formed from organic or inorganic material and photo-alignment films each requiring no alignment treatment enable simplification of the process to reduce the cost, as well as improvement in the reliability and the yield. If an alignment film is subjected to rubbing, the rubbing may cause disadvantages such as liquid crystal contamination due to impurities from rubbing cloth, dot defects due to contaminants, and display unevenness due to uneven rubbing in each liquid crystal panel. On the contrary, alignment films formed from organic or inorganic material and photo-alignment films can eliminate these disadvantages. At least one of the upper and lower substrates preferably includes a polarizing plate on the side opposite to the liquid crystal layer side. The polarizing plate is preferably a circularly polarizing plate. This makes it possible to further improve the transmittance. The polarizing plate may also preferably be a linearly polarizing plate. This makes it possible to give excellent viewing angle characteristics.

In the presence of a vertical electric field, the liquid crystal driving method of the present invention preferably generates the higher electric potential difference between the electrodes of the second electrode pair (for example, counter electrodes disposed in each of the upper and lower substrates) than that between the electrodes of the first electrode pair (for example, a pair of comb-shaped electrodes disposed in any one of the upper and lower substrates).

The driving method of the present invention may include or may not include a mode (initialization process) which performs a driving operation substantially not generating the electric potential difference between entire electrodes of the first electrode pair and the second electrode pair after the vertical electric field is generated. The driving method can control the alignment of the liquid crystal around the edge of at least one of the first electrode pair and the second electrode pair (for example, a pair of comb-shaped electrodes) to suitably control transmittance when the driving method includes the initialization process. The driving method can provide a simple driving operation in addition to provide excellent transmittance when the driving method does not include the initialization process.

The driving operation according to the present invention is performed in the presence of a vertical electric field and may be performed after generation of the vertical electric field of the upper electrode and the lower electrode at the same electric potential.

In the presence of a transverse electric field, the driving operation usually generates the electric potential difference at least between the electrodes of the first electrode pair (for example, between a pair of comb-shaped electrode disposed in any one of the upper and lower substrates). For example, the driving operation may be in a mode such that the higher electric potential difference is generated between electrodes of the first electrode pair than that between the electrodes of the second electrode pair (for example, between the counter electrodes disposed in each of the upper and lower substrates). The driving operation may also be in a mode such that the lower electric potential difference is generated between electrodes of the first electrode pair than that between the electrodes of the second electrode pair when images having low gray scale values are displayed by a transverse electric field between teeth.

The upper and lower substrates of the liquid crystal display panel of the present invention usually constitute a pair of substrates interposing the liquid crystal layer. They each may include an insulating substrate (e.g. glass, resin) as its base material, and the substrates are formed by disposing wirings, electrodes, color filters, and the like on the insulating substrate.

Preferably, at least one of the first electrode pair is a pixel electrode and the substrate including the first electrode pair is an active matrix substrate. The liquid crystal driving method of the present invention is applicable to any liquid crystal display devices such as a transmissive liquid crystal display device, a reflection liquid crystal display device, and a transflective liquid crystal display device.

The present invention is also a liquid crystal display device driven by the liquid crystal driving method of the present invention. Preferable modes of the liquid crystal driving method for the liquid crystal display device of the present invention are the same as the aforementioned preferable modes of the liquid crystal driving method of the present invention. The liquid crystal driving method of the present invention is particularly preferably applicable to a liquid crystal display device of a field sequential driving method. Applications of the liquid crystal display device include displays for devices including personal computers, televisions, onboard devices such as automotive navigation systems, and personal digital assistants such as mobile phones, and display devices capable of displaying a stereoscopic image. Particularly preferably, the liquid crystal display device is applied to devices used at low-temperature conditions, such as onboard devices including automotive navigation systems, and display devices capable of displaying a stereoscopic image.

The configuration of the liquid crystal driving method and the liquid crystal display device of the present invention is not especially limited by other components as long as it essentially includes such components, other configuration usually used for the liquid crystal driving method and the liquid crystal display device may appropriately be applied.

The aforementioned modes may be employed in appropriate combination as long as the combination is not beyond the spirit of the present invention.

### Advantageous Effects of Invention

The liquid crystal driving method and the liquid crystal display device of the present invention can provide a sufficiently high response speed, and can provide a sufficiently excellent contrast ratio by reducing distortion of the electric field and sufficiently reducing transmittance during black display.

### BRIEF DESCRIPTION OF THE DRAWINGS

FIG. 1 is a schematic cross-sectional view showing a liquid crystal display device in the presence of a transverse electric field according to a liquid crystal driving method of Reference Example 1.

FIG. 2 is a schematic cross-sectional view showing a liquid crystal display device in the presence of a vertical electric field according to a liquid crystal driving method of Reference Example 1.

FIG. 3 is a schematic cross-sectional view showing a liquid crystal display device in the presence of a vertical electric field according to a liquid crystal driving method of Embodiment 1.

FIG. 4 is a graph showing brightness (cd/m²) to a voltage (V) during black display according to Embodiment 1.

FIG. 5 is a schematic cross-sectional view showing a liquid crystal display device of a modified example of Embodiment 1.

FIG. 6 is a schematic cross-sectional view showing a liquid crystal display device in the presence of a vertical electric field according to a liquid crystal driving method of Embodiment 2.

FIG. 7 is a graph showing brightness (cd/m²) to a voltage (V) during black display according to Embodiment 2.

FIG. 8 is a schematic cross-sectional view showing a liquid crystal display device in the presence of a vertical electric field according to a liquid crystal driving method of Embodiment 3.

FIG. 9 is a graph showing brightness (cd/m²) to a voltage (V) during black display according to Embodiment 3.

FIG. 10 is a schematic cross-sectional view showing a liquid crystal display device in the presence of a vertical electric field according to a liquid crystal driving method of Embodiment 4.

FIG. 11 is a bar graph showing a transmittance during black display depending on voltage application method according to Embodiment 4.

FIG. 12 is a schematic cross-sectional view showing a liquid crystal display device in the presence of a vertical electric field according to a liquid crystal driving method of Comparative Example 1.

FIG. 13 is a schematic cross-sectional view showing a liquid crystal display device in the presence of a vertical electric field according to a liquid crystal driving method of Comparative Example 2.

FIG. 14 is a schematic cross-sectional view showing a liquid crystal display device in the presence of a vertical electric field according to a liquid crystal driving method of Embodiment 4.

FIG. 15 is a schematic cross-sectional view showing another liquid crystal display device used in a driving method of Embodiment 1.

FIG. 16 is a circuit diagram showing a region of a space part in FIG. 15.

FIG. 17 is a circuit diagram showing a region of a line part in FIG. 15.

FIG. 18 is a schematic cross-sectional view showing a liquid crystal display device of Embodiment 3.

FIG. 19 is a circuit diagram showing a region of a space part in FIG. 18.

FIG. 20 is a circuit diagram showing a region of a line part in FIG. 18.

FIG. 21 is a schematic cross-sectional view showing a liquid crystal display device in the presence of a vertical electric field according to a liquid crystal driving method using three-layered electrodes.

FIG. 22 is a schematic cross-sectional view showing a liquid crystal display device in the presence of a vertical electric field according to a liquid crystal driving method of the present invention.

FIG. 23 is a schematic cross-sectional view showing a liquid crystal display device immediately after an initialization process is performed in a liquid crystal driving method.

FIG. 24 is a schematic cross-sectional view showing one example of a liquid crystal display device used in a liquid crystal driving method of the present embodiment.

FIG. 25 is a schematic plan view showing an active drive element and its vicinity used in the present embodiment.

FIG. 26 is a schematic cross-sectional view showing an active drive element and its vicinity used in the present embodiment.

FIG. 27 is a schematic cross-sectional view showing a liquid crystal display device in the presence of a vertical electric field according to a liquid crystal driving method of Embodiment 5.

### DESCRIPTION OF EMBODIMENTS

The present invention will be mentioned in more detail referring to the drawings in the following embodiments, but is not limited to these embodiments. The term “pixel” herein also means a subpixel unless otherwise specified. A pair of substrates interposing the liquid crystal layer are also referred to as an upper and lower substrates, and, with respect to them, the substrate on the display side is also referred to as an upper substrate and the substrate on the side opposite to the display side is also referred to as a lower substrate. With respect to the electrodes disposed in the substrate, the electrodes on the display side are also referred to as upper electrodes and the electrodes on the side opposite to the display side are also referred to as lower electrodes. The circuit substrate (lower substrate) of the present embodiment is also referred to as a TFT substrate or an array substrate because it includes a thin film transistor element (TFT). In Embodiments 1 to 4, the TFT is turned into the ON state and thereby a voltage is applied to at least one electrode (pixel electrode) of the pair of the comb-shaped electrodes in both the rising (application of transverse electric field) and the falling (application of vertical electric field). The mode is preferable from the viewpoint of a display speed.

In each embodiment, the components or parts having the same function are given the almost same reference number, except that hundreds digits are changed. In the drawings, unless otherwise noted, the symbol (i) indicates an electric potential of one of the comb-shaped electrodes in the upper layer of the lower substrate; the symbol (ii) indicates an electric potential of the other of the comb-shaped electrodes in the upper layer of the lower substrate; the symbol (iii) indicates an electric potential of the planar electrode in the lower layer of the lower substrate; and the symbol (iv) indicates an electric potential of the planar electrode in the upper substrate. The two pairs of electrodes are preferably constituted by (i) and (ii), and (iii) and (iv). However, the effects of the present invention can be exerted even when a constitution other than these constitutions is used.

### Reference Example 1

FIG. 1 is a schematic cross-sectional view showing a liquid crystal display device in the presence of a transverse electric field according to a liquid crystal driving method of Reference Example 1. FIG. 2 is a schematic cross-sectional view showing a liquid crystal display device in the presence of a vertical electric field according to a liquid crystal driving method of Reference Example 1.

In each of FIG. 1 and FIG. 2, the dot line indicates the direction of an electric field generated. The vertical-alignment liquid crystal display device of Reference Example 1 includes a three-layered electrode structure (upper electrodes of the lower substrate, which serve as the second layer, are a pair of comb-shaped electrodes) using liquid crystal molecules 31 which are a liquid crystal having positive anisotropy of dielectric constant (positive-type liquid crystal). In rising, as shown in FIG. 1, a transverse electric field generated by the electric potential difference of 14 V between a pair of comb-shaped electrodes 16 (for example, consisting of a comb-shaped electrode 17 at an electric potential of 0 V and a comb-shaped electrode 19 at an electric potential of 14 V) rotates the liquid crystal molecules. In this case, substantially no electric potential difference is generated between the substrates (between a lower electrode 13 at an electric potential of 7 V and a counter electrode 23 at an electric potential of 7 V).

In falling, as shown in FIG. 2, a vertical electric field generated by the electric potential difference of about 7 V between the substrates (for example, between each of the lower electrode 13, the comb-shaped electrode 17, and the comb-shaped electrode 19 at an electric potential of 14 V and the counter electrode 23 at an electric potential of 7 V) rotates the liquid crystal molecules. In this case, substantially no electric potential difference is generated between the pair of comb-shaped electrodes 16 (for example, consisting of the comb-shaped electrode 17 at an electric potential of 14 V and the comb-shaped electrode 19 at an electric potential of 14 V).

In both the rising and the falling, an electric field rotates the liquid crystal molecules to provide a high response speed. In other words, the transverse electric field between the pair of the comb-shaped electrodes can lead to the ON state to give a high transmittance in the rising, whereas the vertical electric field between the substrates can lead to the ON state to give a high response speed in the falling.

### Embodiment 1

### The Case that a Passivation Layer (PAS) Exists Between the Upper Electrode and the Lower Electrode

FIG. 3 is a schematic cross-sectional view showing a liquid crystal display device in the presence of a vertical electric field according to a liquid crystal driving method of Embodiment 1. In Embodiment 1, the electric potential of 14 V of the lower electrode 13, the comb-shaped electrode 17, and the comb-shaped electrode 19 in Reference Example 1 is changed as shown in FIG. 3. Embodiment 1 can also exert the effects of high transmittance and high response speed in the same manner as in Reference Example 1 and can further exert the effects to be mentioned later.

FIG. 4 is a graph showing brightness (cd/m²) to a voltage (V) during black display according to Embodiment 1.

Experimental conditions are as follows:

Line/space in the upper electrodes (the pair of the comb-shaped electrodes)=2.5 μm/3 μm

The liquid crystal layer: ∈_{⊥} (dielectric constant in an orthogonal direction to an axis of liquid crystal molecules)=4, thickness of the liquid crystal layer d_{lc}=3.7 μm.

The passivation layer (SiO₂): Dielectric constant ∈ₚₐₛ=6.8, layer thickness dₚₐₛ=0.3 μm

An overcoat layer (also referred to as an OC layer) is not provided.

Voltage:

One of the upper electrodes (i); 7 V to 7.5 V

The other of the upper electrodes (ii); 7 V to 7.5 V

The lower electrode (iii); 7.5 V

The counter electrode (iv); 0 V

A transmittance was measured with voltage of the upper electrodes (i) and (ii) being changed between 7 V to 7.5 V.

A black transmittance was the lowest when the voltage of the upper electrodes (i) and (ii) was 7.3 V. Therefore, the best contrast ratio was obtained when the voltage of the upper electrode was 0.2 V lower than the voltage of the lower electrode in the case that the voltage of the lower electrode (iii) was 7.5 V because the alignment direction of the liquid crystal was capable of being aligned. On the contrary, the same effect can be obtained when the voltage of the lower electrode is 0.21 V higher than the voltage of the upper electrodes in the case that the voltage of the upper electrodes (i) and (ii) is 7.5 V.

FIG. 5 is a schematic cross-sectional view showing a liquid crystal display device of a modified example of Embodiment 1.

In Embodiment 1, the experiment was performed when the upper electrodes were separated into (i) and (ii). However, the upper electrode may be one electrode (slit electrode 117s). A simulation result during black display (at falling) provides the same result as the case that the upper electrodes are separated into two electrodes. This mode can also reduce brightness during black display and exert the effect of contrast ratio improvement in the same manner as in Embodiment 1.

Embodiment 1 and the following Embodiments use a liquid crystal (positive-type liquid crystal) constituted by liquid crystal molecules having positive anisotropy of dielectric constant and use of the positive-type liquid crystal is preferable. The driving operation according to the present invention is applied during white display when a liquid crystal (negative-type liquid crystal) constituted by liquid crystal molecules having negative anisotropy of dielectric constant is used. In other words, distortion of the electric field around the edge of the upper electrode is caused and an azimuth of the liquid crystal is changed because distortion of voltage is generated when the same electric field is applied to the upper electrode and the lower electrode during white display. Application of the driving operation according to the present invention can reduce the distortion of the electric field and entire liquid crystal easily aligns in the same direction to improve transmittance. This can improve the contrast ratio. Each electrode is formed from ITO (Indium Tin Oxide), and in addition to ITO, an electrode may be formed from IZO (Indium Zinc Oxide).

In the present description, the electric potentials of the pair of the comb-shaped electrodes are indicated by the symbols (i) and (ii), the electric potential of the planar electrode in the lower substrate is indicated by the symbol (iii), and the electric potential of the planar electrode in the upper substrate is indicated by the symbol (iv).

As shown in FIG. 3, the liquid crystal display panel according to Embodiment 1 includes an array substrate 10, a liquid crystal layer 30, and a counter substrate 20 (color filter substrate) stacked in the order set forth from the back side to the viewing side of the liquid crystal display device. As shown in FIG. 22 mentioned later, the liquid crystal display device of Embodiment 1 aligns liquid crystal molecules in a vertical direction by the electric potential difference between a pair of substrates when the voltage difference between the comb-shaped electrodes is less than a threshold voltage. An electric field generated between the comb-shaped electrodes 17 and 19 (the pair of the comb-shaped electrodes 16) that are the upper electrodes disposed on the glass substrate 11 (lower substrate) tilts the liquid crystal molecules in the horizontal direction between the comb-shaped electrodes when the voltage difference between the comb-shaped electrodes is not lower than the threshold voltage, thereby controlling the amount of light transmitted. The planar lower electrode 13 (counter electrode 13) is disposed such that it interposes an insulating layer (passivation layer) 15 with the comb-shaped electrodes 17 and 19 (the pair of the comb-shaped electrodes 16) that are the upper electrodes. The insulating layer 15 may be formed from, for example, an oxide film (e.g. SiO₂). Instead of the oxide film, a nitride film (e.g. SiN), an acrylic resin, or combination of these materials can be used.

Although not shown in FIG. 3, a polarizing plate is disposed on each substrate at the side opposite to the liquid crystal layer. The polarizing plate may be a circularly polarizing plate or may be a linearly polarizing plate. An alignment film is disposed on the liquid crystal layer side of each substrate. The alignment films each may be an organic alignment film or may be an inorganic alignment film as long as they align the liquid crystal molecules vertically to the film surface.

A voltage supplied from an image signal line is applied to the comb-shaped electrode 19, which drives the liquid crystal, through a thin film transistor element (TFT) at the timing when a pixel is selected by a scanning signal line. The comb-shaped electrode 17 and the comb-shaped electrode 19 are formed on the same layer in the present embodiment and are preferably in a mode where they are formed on the same layer. Still, the comb-shaped electrodes may be formed on different layers as long as the voltage difference is generated between the comb-shaped electrodes to apply a transverse electric field and provides one effect of the present invention, that is, the effect of improving the transmittance. The comb-shaped electrode 19 is connected to a drain electrode that extends from the TFT through a contact hole. In FIG. 3, the lower electrode 13 and the counter electrode 23 have planar shapes.

The electrode width L of each comb-shaped electrode in the present embodiment is 2.5 μm, and it is preferably 2 μm or greater, for example. The electrode gap S between the comb-shaped electrodes is 3 μm, and it is preferably 2 μm or greater, for example. The upper limit thereof is preferably 7 μm, for example. The ratio (L/S) between the electrode gap S and the electrode width L is preferably 0.4 to 3, for example. The lower limit thereof is more preferably 0.5, whereas the upper limit thereof is more preferably 1.5.

The cell gap d_{lc} is 3.7 μm. The cell gap is preferably 2 μm to 7 μm. The cell gap d_{lc} (thickness of the liquid crystal layer) herein is preferably calculated by averaging the thicknesses of the liquid crystal layer in the liquid crystal display panel.

The liquid crystal display device including the liquid crystal display panel of Embodiment 1 may appropriately include the components that usual liquid crystal display devices include (e.g. light source). The same shall apply to the following embodiments.

### Embodiment 2

### The Case that an Insulating Layer (JAS) Exists Between Electrodes

FIG. 6 is a schematic cross-sectional view showing a liquid crystal display device in the presence of a vertical electric field according to a liquid crystal driving method of Embodiment 2.

Properties in Embodiment 2 are measured in the same manner as in those in Embodiment 1 except that conditions of an insulating layer are changed and the applied voltage to an electrode is changed.

FIG. 7 is a graph showing brightness (cd/m²) to a voltage (V) during black display according to Embodiment 2.

Experimental conditions are as follows:

Line/space in the upper electrodes (the pair of the comb-shaped electrodes)=2.5 μm/3 μm

The liquid crystal layer: Dielectric constant in an orthogonal direction to an axis of liquid crystal molecules ∈_{⊥}=4, thickness of the liquid crystal layer d_{lc}=3.7 μm.

The insulating layer (JAS): Dielectric constant ∈ⱼₐₛ=3.8, layer thickness dⱼₐₛ=1.5 μm

An overcoat layer is not provided.

Voltage:

One of the upper electrodes (i); 2 V to 7.5 V

The other of the upper electrodes (ii); 2 V to 7.5 V

The lower electrode (iii); 7.5 V

The counter electrode (iv); 0 V

A transmittance was measured with voltage of the upper electrodes (i) and (ii) being changed between 2 V to 7.5 V.

A black transmittance was the lowest when the voltage of the upper electrodes (i) and (ii) was 3 V. Therefore, the best contrast ratio was obtained when the voltage of the upper electrode was 4.5 V lower than the voltage of the lower electrode in the case that the voltage of the lower electrode (iii) was 7.5 V. On the contrary, the same effect can be obtained when the voltage of the lower electrode (iii) is 11.25 V higher than the voltage of the upper electrodes in the case that the voltage of the upper electrodes (i) and (ii) is 7.5 V.

In Embodiment 2, the experiment was performed when the upper electrodes were separated into (i) and (ii). However, the upper electrode may be one electrode. A simulation result during black display (at falling) provides the same result as the case that the upper electrodes are separated into two electrodes. This mode can also reduce brightness during black display and exert the effect of contrast ratio improvement in the same manner as in Embodiment 2.

In Embodiment 2, a relation between a voltage V₁ of the upper electrodes and a voltage V₂ of the lower electrode is in accordance with a following formula:

V₁/V₂∝<C₁/(C₁+C₂).

In other words, the voltage ratio is proportional to a dielectric constant, a thickness, and an area of the dielectric film (refer to the “calculating formula” mentioned later for details).

The reference numbers in the drawings relating to Embodiment 2 are the same as those in the reference numbers in the drawings relating to Embodiment 1, except that 1 is added to a hundreds digit.

### Embodiment 3

### The Case that an Overcoat Layer Exists

FIG. 8 is a schematic cross-sectional view showing a liquid crystal display device in the presence of a vertical electric field according to a liquid crystal driving method of Embodiment 3. Properties in Embodiment 3 are measured in the same manner as in those in Embodiment 1 except that an overcoat layer 225 is provided in a substrate 220 and the applied voltage to an electrode is changed.

FIG. 9 is a graph showing brightness (cd/m²) to a voltage (V) during black display according to Embodiment 3.

Experimental conditions are as follows:

The overcoat layer is disposed at the liquid crystal layer side of the counter electrode.

Line/space in the upper electrodes (the pair of the comb-shaped electrodes)=2.5 μm/3 μm

The liquid crystal layer: Dielectric constant in an orthogonal direction to an axis of liquid crystal molecules ∈_{⊥}=4, thickness of the liquid crystal layer d_{lc}=3.7

The passivation layer (SiO₂): Dielectric constant ∈ₚₐₛ=6.8, layer thickness dₚₐₛ=0.3 μm

The overcoat layer: Dielectric constant ∈_{oc}=3.8, layer thickness d_{oc}=1.5 μm

Voltage:

One of the upper electrodes (i); 7 V to 7.5 V

The other of the upper electrodes (ii); 7 V to 7.5 V

The lower electrode (iii); 7.5 V

The counter electrode (iv); 0 V

A transmittance was measured with voltage of the upper electrodes (i) and (ii) being changed between 7 V to 7.5 V.

A black transmittance was the lowest when the voltage of the upper electrodes (i) and (ii) was 7.3 V. Therefore, the best contrast ratio was obtained when the voltage of the upper electrode was 0.2 V lower than the voltage of the lower electrode in the case that the voltage of the lower electrode (iii) was 7.5 V. On the contrary, the same effect can be obtained when the voltage of the lower electrode (iii) is 0.21 V higher than the voltage of the upper electrodes in the case that the voltage of the upper electrodes (i) and (ii) is 7.5 V. As mentioned above, it was found that presence or absence of OC does not change an optimum voltage applied to the upper electrodes.

In Embodiment 3, the experiment was performed when the upper electrodes were separated into (i) and (ii). However, the upper electrode may be one electrode. A simulation result during black display (at falling) provides the same result as the case that the upper electrodes are separated into two electrodes. This mode can also reduce brightness during black display and exert the effect of contrast ratio improvement in the same manner as in Embodiment 3.

### Embodiment 4

### The Case that a Lower Layer Slit Exists

FIG. 10 is a schematic cross-sectional view showing a liquid crystal display device in the presence of a vertical electric field according to a liquid crystal driving method of Embodiment 4. Properties in Embodiment 4 are measured in the same manner as in Embodiment 3 except that a slit is provided in a lower electrode 313 of a lower substrate and the applied voltage to an electrode is changed. In Embodiment 4, one of comb-shaped electrodes 317 does not overlap a lower electrode 313 or overlaps a part of the lower electrode 313, and the other of the comb-shaped electrodes 319 overlaps at least a part of the lower electrode 313. An overlapped region of the comb-shaped electrode 317 and the lower electrode 313 is smaller than an overlapped region of the comb-shaped electrode 319 and the lower electrode 313. As mentioned later, the driving operation in which the comb-shaped electrode 317 has a higher absolute value of an applied voltage than that of the comb-shaped electrode 319 is performed, when an alignment direction of the liquid crystal is driven so as to align in a vertical direction to the main faces of the substrates in such a mode. This mode is preferred in that the effects of the present invention can significantly be exerted.

The present invention can also be applied to a design in which the lower electrode is disposed only between teeth (at the portion overlapping a space). However, voltage setting is almost the same as the case that the lower layer slit is not provided.

FIG. 11 is a bar graph showing a transmittance during black display depending on voltage application method according to Embodiment 4.

Experimental conditions are as follows:

Line/space in the upper electrodes (the pair of the comb-shaped electrodes)=2.5 μm/3 μm

Width of the lower layer slit: 1.75 μm

The liquid crystal layer: Dielectric constant in an orthogonal direction to an axis of liquid crystal molecules ∈_{∈}=4, thickness of the liquid crystal layer d_{lc}=3.7 μm.

The passivation film (SiO₂): Dielectric constant ∈ₚₐₛ=6.8, thickness dₚₐₛ=0.3 μm

The overcoat layer: Dielectric constant ∈_{oc}=3.8, layer thickness d_{oc}=1.5 μm

Voltage:

One of the upper electrodes (i); 7 V to 7.5 V

The other of the upper electrodes (ii); 7 V to 7.5 V

The lower electrode (iii); 7.5 V

The counter electrode (iv); 0 V

A white transmittance becomes better while a black transmittance becomes worse by providing the slit in the lower electrode (see FIG. 13).

Examples of improving methods preferably include the case 1: a method for setting as (i) and (ii)<(iii) (in the same manner as in Embodiments 1 to 3), and the case 2: a method for setting as (ii)<(i) (see FIG. 14). Particularly, a combination of the case 1 and the case 2 is preferred.

Experimental results are as follows:

A black state was measured in the case of a voltage application method B: (i)=7.3 V, (ii)=7.1 V, and (iii)=7.5 V. As shown in FIG. 11, the present inventors have confirmed that a transmittance (transmittance during black display) in the case of the voltage application method B is almost a half to a transmittance (transmittance during black display) in the case of a voltage application method A: (ii)=7.5 V, (ii)=7.5 V, and (iii)=7.5 V, and thus the contrast ratio becomes as twice as high.

### (Principle of Embodiment 4)

FIG. 12 is a schematic cross-sectional view showing a liquid crystal display device in the presence of a vertical electric field according to a liquid crystal driving method of Comparative Example 1. A lower electrode including no slit makes the contrast ratio relatively high compared with a lower electrode including a slit because the electric field is not so distorted. Both of the Comparative Example 1 and Reference Example 1 relate to the liquid crystal display device in which two pairs of electrodes switch the state between two ON electric fields as described in the previous applications.

FIG. 13 is a schematic cross-sectional view showing a liquid crystal display device in the presence of a vertical electric field according to a liquid crystal driving method of Comparative Example 2. The vertical electric field is not applied to a place (a place where the comb-shaped electrodes are not overlapped with the lower electrode in a plan view of the main faces of the substrates) where the lower electrode does not exist when the slit is provided in the lower electrode. In this case, the liquid crystal on the slit in the lower electrode (in FIG. 13, liquid crystal molecules surrounded by alternate long and short dash lines) tilts more and the contrast ratio is reduced more because the electric field is obliquely applied to the place where the lower electrode does not exist from the place where the lower electrode exists as shown in FIG. 13.

FIG. 14 is a schematic cross-sectional view showing a liquid crystal display device in the presence of a vertical electric field according to a liquid crystal driving method of Embodiment 4.

A voltage applied to one of the pair of the comb-shaped electrodes (i) (electrode overlapped with a slit between the lower electrodes) that is the upper electrode is set larger than a voltage applied to the other of the pair of the comb-shaped electrodes (ii) (electrode overlapped with the lower electrode), and thereby a transverse electric field is generated between (i) and (ii). This electric field erases the oblique electric field from the lower electrode, and thus, the liquid crystal is aligned in a vertical direction and the contrast ratio is improved.

### Calculating Formula

The case that two layers of liquid crystal layer and insulating layer exist (The case that the overcoat layer does not exit)

FIG. 15 is a schematic cross-sectional view showing another liquid crystal display device used in a driving method of Embodiment 1. In FIG. 15, a liquid crystal layer thickness at the space part d_{lc}(S) and a liquid crystal layer thickness at the line part d_{lc}(L) are the same. Similarly, an insulating layer thickness at the space part dₚₐₛ(S) and an insulating layer thickness at the line part dₚₐₛ(L) are the same. FIG. 16 is a circuit diagram showing a region of a space part in FIG. 15. In FIG. 16, C₁ represents a capacitance stored in the liquid crystal layer at the space part, and V₁ represents a voltage applied to the liquid crystal layer at the space part. C₂ represents a capacitance stored in the passivation layer at the space part, and V₂ represents a voltage applied to the passivation layer at the space part. FIG. 17 is a circuit diagram showing a region of a line part in FIG. 15. In FIG. 17, C₃ represents a capacitance stored in the liquid crystal layer at the line part, and V₃ represents a voltage applied to the liquid crystal layer at the line part.

The calculating formula when two layers of the liquid crystal layer and the insulating layer exist (the overcoat layer does not exist) is as follows.

C=∈₀∈×S/d

Cₐₗₗ=(C₁+C₂)/(C₁×C₂)

V₁=C₂/(C₁+C₂)×V₃

V₂=C₁/(C₁+C₂)×V₃

here, C₁=C₃.

∈ represents a dielectric constant of each layer. S represents an area in a plan view of the main face of each layer. d represents a layer thickness (μm) of each layer.

When the dielectric film is a passivation film, liquid crystal: ∈_{∈} (dielectric constant in an orthogonal direction to an axis of liquid crystal molecules)=4, a liquid crystal cell thickness d_{lc}=3.7 μm. The passivation film (SiO₂): Dielectric constant ∈ₚₐₛ=6.8, thickness dₚₐₛ=1.5 μm. A thickness of the passivation film (SiO₂) is different from the thickness in Embodiment 1. Line (L)/space (S) in the upper electrodes (the pair of the comb-shaped electrodes) is 2.5 μm/3 μm. A voltage applied to the lower electrode is 7.5 V.

The best contrast ratio is obtained when the electric potential V₁ of the liquid crystal at the space part is equal to the electric potential V₃ of the liquid crystal at the line part. This is one of the preferable modes in the present embodiment. In this case, a relation between V₁ and V₃ satisfies the following formulas.

V₁/V₃∝C₁/(C₁+C₂)

C₁,C₂∝∈₀∈×S/d

The “∝” represents a relationship of proportion. The “∝” mentioned later is in the same manner as in the above definition. The above two formulas show how the voltage behaves when the film thickness or the value of E varies. An optimum voltage can be set by setting a voltage so as to satisfy the proportional relationship represented by these formulas. In other words, a particularly preferable mode of the liquid crystal driving method of the present invention is to set the voltage as mentioned above in terms of particularly improving the contrast ratio.

The case that three layers of liquid crystal layer, insulating layer, and overcoat layer exist (The case that the overcoat layer exists) FIG. 18 is a schematic cross-sectional view showing a liquid crystal display device of Embodiment 3. In FIG. 18, an overcoat layer thickness at the space part d_{oc}(S) and an overcoat layer thickness at the line part d_{oc}(L) are the same. Similarly, a liquid crystal layer thickness at the space part d_{lc}(S) and a liquid crystal layer thickness at the line part d_{lc}(L) are the same, and an insulating layer thickness at the space part dₚₐₛ(S) and an insulating layer thickness at the line part dₚₐₛ(L) are the same. FIG. 19 is a circuit diagram showing a region of a space part in FIG. 18. In FIG. 19, C₁ represents a capacitance stored in the overcoat layer at the space part, and V₁ represents a voltage applied to the overcoat layer at the space part. C₂ represents a capacitance stored in the liquid crystal layer at the space part, and V₂ represents a voltage applied to the liquid crystal layer at the space part. C₃ represents a capacitance stored in the passivation layer at the space part, and V₃ represents a voltage applied to the passivation layer at the space part. FIG. 20 is a circuit diagram showing a region of a line part in FIG. 18. In FIG. 20, C₄ represents a capacitance stored in the overcoat layer at the line part, and V₄ represents a voltage applied to the overcoat layer at the line part. C₅ represents a capacitance stored in the liquid crystal layer at the line part, and V₅ represents a voltage applied to the liquid crystal layer at the line part.

Calculating formulas when three layers of the liquid crystal layer, the insulating layer, and the overcoat layer exist (the overcoat layer (OC) exists) are as follows.

C=∈₀∈×S/d

Cₐₗₗ=(C₁+C₂)/(C₁×C₂×C₃)

V₁=(C₂×C₃)/(C₁×C₂+C₂×C₃+C₁×C₃)×Vₐₗₗ

V₂=(C₁×C₃)/(C₁×C₂+C₂×C₃+C₁×C₃)×Vₐₗₗ

V₃=(C₁×C₂)/(C₁×C₂+C₂×C₃+C₁×C₃)×Vₐₗₗ

here, Vₐₗₗ=V₄+V₅, C₂=C₅, and C₁=C₄.

The liquid crystal layer: Dielectric constant in an orthogonal direction to an axis of liquid crystal molecules ∈_{∈}=4, thickness of the liquid crystal layer d_{lc}=3.7 μm.

The passivation layer (SiO₂): Dielectric constant ∈ₚₐₛ=6.8, layer thickness dₚₐₛ=0.3 μm

The overcoat layer: Dielectric constant ∈_{oc}=3.8, layer thickness d_{oc}=1.5 μm

Line (L)/space (S) in the upper electrodes (the pair of the comb-shaped electrodes) is 2.5 μm/3 μm. A voltage applied to the lower electrode is 7.5 V.

The best contrast ratio is obtained when the electric potential V₂ of the liquid crystal at the space part is equal to the electric potential V₅ of the liquid crystal at the line part. This is one of the preferable modes in the present embodiment. In this case, a relation between V₂ and V₅ is constant and not depending on C₁.

V₂/V₅∝C₂/(C₂+C₃)

From the viewpoint of sufficiently increasing the response speed in falling, an increase in the dielectric constant ∈_{oc} of the overcoat layer is also preferred. For example, the dielectric constant ∈_{oc} of the overcoat layer is preferably 3.0 or more. Here, the upper limit thereof is preferably 9 or less.

In the embodiments of the present invention, an oxide semiconductor TFT (e.g. IGZO) is preferably used. The following will describe this oxide semiconductor TFT in detail.

At least one of the upper and lower substrates usually includes a thin film transistor element. The thin film transistor element preferably includes an oxide semiconductor. In other words, an active layer of an active drive element (TFT) in the thin film transistor element is preferably formed using an oxide semiconductor film such as zinc oxide instead of a silicon semiconductor film. Such a TFT is referred to as an “oxide semiconductor TFT”. The oxide semiconductor characteristically shows a higher carrier mobility and less unevenness in its properties than amorphous silicon. Thus, the oxide semiconductor TFT is driven faster than an amorphous silicon TFT, has a high driving frequency, and is suitably used for driving of higher-definition next-generation display devices. In addition, the oxide semiconductor film is formed by an easier process than a polycrystalline silicon film. Thus, the oxide semiconductor film is advantageously applied to devices requiring a large area.

The following characteristics markedly appear in the case of applying the liquid crystal driving method of the present embodiments especially to FSDs (field sequential display devices).

(1) The pixel capacitance is higher than that in a usual VA (vertical alignment) mode (FIG. 24 is a schematic cross-sectional view showing one example of a liquid crystal display device used in a liquid crystal driving method of the present embodiment; in FIG. 24, a large capacitance is generated between the upper electrode and the lower electrode at the portion indicated by an arrow, and thus the pixel capacitance is higher than in the liquid crystal display device of usual vertical alignment (VA) mode).

(2) One pixel is equivalent to three pixels (RGB), and thus the capacitance of one pixel is trebled.

(3) The gate ON time is very short because 240 Hz or higher driving is required.

Advantages of applying the oxide semiconductor TFT (e.g. IGZO) are as follows.

Based on the characteristics (1) and (2), a 52-inch device has a pixel capacitance of about 20 times as high as a 52-inch UV2A 240-Hz drive device.

Thus, a transistor produced using conventional a-Si is as great as about 20 times or more, disadvantageously resulting in an insufficient aperture ratio.

The mobility of IGZO is about 10 times that of a-Si, and thus the size of the transistor is about 1/10.

Although the liquid crystal display device using color filters (RGB) includes three transistors, the FSD type device includes only one transistor. Thus, the device can be produced in a size as small as or smaller than that with a-Si.

As the size of the transistor becomes smaller, the Cgd capacitance also becomes smaller. This reduces the load on the source bus lines.

### Specific Example

FIG. 25 and FIG. 26 each show a structure (example) of the oxide semiconductor TFT. FIG. 25 is a schematic plan view showing an active drive element and its vicinity used in the present embodiment. FIG. 26 is a schematic cross-sectional view showing an active drive element and its vicinity used in the present embodiment. The symbol T indicates a gate and source terminal. The symbol Cs indicates an auxiliary capacitance.

The following will describe one example (the corresponding portion) of a production process of the oxide semiconductor TFT.

Active layer oxide semiconductor layers 105a and 105b of an active drive element (TFT) using the oxide semiconductor film are formed as follows.

At first, for example, an In—Ga—Zn—O semiconductor (IGZO) film with a thickness of 30 nm or greater but 300 nm or smaller is formed on an insulating film 113i by a sputtering method. Then, a resist mask is formed by photolithography so as to cover predetermined regions of the IGZO film. Next, portions of the IGZO film other than the regions covered by the resist mask are removed by wet etching. Thereafter, the resist mask is peeled off. This provides island-shaped oxide semiconductor layers 105a and 105b. The oxide semiconductor layers 105a and 105b may be formed using other oxide semiconductor films instead of the IGZO film.

Next, an insulating film 107 is deposited on the whole surface of a substrate 111g and then the insulating film 107 is patterned.

Specifically, at first, an SiO₂ film (thickness: about 150 nm, for example) as the insulating film 107 is formed on the insulating film 113i and the oxide semiconductor layers 105a and 105b by a CVD method.

The insulating film 107 preferably includes an oxide film such as SiOy.

Use of the oxide film can recover oxygen deficiency on the oxide semiconductor layers 105a and 105b by the oxygen in the oxide film, and thus it more effectively suppresses oxygen deficiency on the oxide semiconductor layers 105a and 105b. Here, a single layer consists of an SiO₂ film is used as the insulating film 107. Still, the insulating film 107 may include a stacked structure of an SiO₂ film as a lower layer and an SiNx film as an upper layer.

The thickness (in the case of a stacked structure, the sum of the thicknesses of the layers) of the insulating film 107 is preferably 50 nm or greater but 200 nm or smaller. The insulating film with a thickness of 50 nm or greater more securely protects the surfaces of the oxide semiconductor layers 105a and 105b in the step of patterning the source and drain electrodes. If the thickness of the insulating film exceeds 200 nm, the source electrodes and the drain electrodes may have a higher step, so that disconnection may occur.

The oxide semiconductor layers 105a and 105b in the present embodiment are preferably formed from a Zn—O semiconductor (ZnO), an In—Ga—Zn—O semiconductor (IGZO), an In—Zn—O semiconductor (IZO), or a Zn—Ti—O semiconductor (ZTO). Particularly preferred is an In—Ga—Zn—O semiconductor (IGZO).

The present mode provides certain effects in combination with the above oxide semiconductor TFT. Still, the present mode can be driven using a known TFT element such as an amorphous Si TFT or a polycrystalline Si TFT.

### Embodiment 5

FIG. 27 is a schematic cross-sectional view showing a liquid crystal display device in the presence of a vertical electric field according to a liquid crystal driving method of Embodiment 5. FIG. 27 is a structural example when electrodes exist in two layers. In FIG. 27, there are no counter electrodes. A positive-type liquid crystal is used as the liquid crystal material. An initial alignment may be a vertical alignment or a horizontal alignment. A TBA mode in the vertical alignment and a FFS mode in the horizontal alignment can be preferably used. As mentioned above, a voltage applied to the upper electrodes is desirably lower than a voltage applied to the lower electrode as exemplified in FIG. 27, instead of applying ±7.5 V to all electrodes during black display. Embodiment 5 is in the same manner as in Embodiment 1 except conditions mentioned above. Also in Embodiment 5, an oxide semiconductor TFT mentioned above can be preferably applied.

The liquid crystal display device driven by the liquid crystal driving method of aforementioned embodiments makes the production easy and provides a high transmittance. Further, this is capable of achieving a response speed that can implement a field sequential mode, and is particularly suitable to apply to the liquid crystal display device of the field sequential mode. Preferably, this is also applicable to onboard display devices and a liquid crystal display devices capable of stereoscopic vision (3D liquid crystal display devices).

Electrode structures according to the liquid crystal driving method and the liquid crystal display device of the present invention can be confirmed by microscopic observation such as SEM (Scanning Electron Microscope) observation in a TFT substrate and the counter substrate. The liquid crystal driving method of the present invention can be confirmed by verifying a driving voltage using a common method in the technical field of the present invention.

The aforementioned modes of the embodiments may be employed in appropriate combination as long as the combination is not beyond the spirit of the present invention.

The present application claims priority to Patent Application No. 2011-227410 filed in Japan on Oct. 14, 2011 under the Paris Convention and provisions of national law in a designated State, the entire contents of which are hereby incorporated by reference.

### REFERENCE SIGNS LIST

10, 110, 210, 310, 410, 510, 610, 710, 810: array substrate
11, 21, 111, 121, 211, 221, 311, 321, 411, 421, 511, 521, 611, 621, 711, 721, 811, 821: glass substrate
13, 113, 213, 313, 413, 513, 613, 713, 813: lower electrode
15, 115, 215, 315, 415, 515, 615, 715, 815: insulating layer
16: a pair of comb-shaped electrodes
17, 19, 117, 119, 217, 219, 317, 319, 417, 419, 517, 519, 617,
619, 717, 719, 817, 819: comb-shaped electrodes
20, 120, 220, 420, 520, 620, 720, 820: counter substrate
23, 123, 223, 323, 423, 523, 623, 723: counter electrode
30, 130, 230, 430, 530, 630, 730, 830: liquid crystal layer
31, 431, 531: liquid crystal (liquid crystal molecules)
101a: gate line
101b: auxiliary capacitance line
101c: connection portion
111g: substrate
113i: insulating film (gate insulator)
105a, 105b: oxide semiconductor layer (active layer)
107: insulating layer (etching stopper, protection film)
109as, 109ad, 109b, 115b: opening
111as: source line
111ad: drain line
111c, 117c: connection portion
113p: protection film
117pix: pixel electrode
201: pixel portion
202: terminal-located region
Cs: auxiliary capacitance
T: gate and source terminal

1-13. (canceled)

14. A liquid crystal driving method of driving a liquid crystal using electrodes at a liquid crystal layer side and an electrode opposite to the liquid crystal layer side disposed in one of upper and lower substrates, the liquid crystal driving method comprising:
performing a driving operation in which the electrode opposite to the liquid crystal layer side has a higher absolute value of an applied voltage than that of the electrodes at the liquid crystal layer side to align an alignment direction of the liquid crystal in a vertical direction or a horizontal direction to main faces of the substrates.

15. The liquid crystal driving method according to claim 14, wherein the electrodes at the liquid crystal layer side are a pair of comb-shaped electrodes.

16. The liquid crystal driving method according to claim 15, wherein the pair of comb-shaped electrodes are allowed to have different electric potentials at a threshold voltage or higher.

17. A liquid crystal driving method of driving a liquid crystal using electrodes at a liquid crystal layer side and an electrode opposite to the liquid crystal layer side disposed in one of upper and lower substrates,
wherein the electrodes at the liquid crystal layer side are a pair of comb-shaped electrodes that are allowed to have different electric potentials at a threshold voltage or higher, and
the liquid crystal driving method comprising:
performing a driving operation in which one of the pair of the comb-shaped electrodes has a higher absolute value of an applied voltage than that of the other of the pair of the comb-shaped electrodes to align an alignment direction of the liquid crystal in a vertical direction or a horizontal direction to main faces of the substrates.

18. The liquid crystal driving method according to claim 14, wherein the electrode opposite to the liquid crystal layer side is an electrode including a slit.

19. The liquid crystal driving method according to claim 18, wherein the one of the pair of the comb-shaped electrodes does not overlap the electrode including the slit or overlaps a part of the electrode including the slit in a plan view of the main faces of the substrates,
the other of the pair of the comb-shaped electrodes overlaps at least a part of the electrode including the slit in a plan view of the main faces of the substrates,
an overlapped region of the one of the pair of the comb-shaped electrodes and the electrode including the slit is smaller than an overlapped region of the other of the pair of the comb-shaped electrodes and the electrode including the slit, and
the liquid crystal driving method comprising:
performing a driving operation in which the one of the pair of the comb-shaped electrodes has a higher absolute value of an applied voltage than that of the other of the pair of the comb-shaped electrodes to align the alignment direction of the liquid crystal in a vertical direction or a horizontal direction to the main faces of the substrates.

20. The liquid crystal driving method according to claim 14, comprising:
performing the driving operation to align the alignment direction of the liquid crystal in a vertical direction to the main faces of the substrates when the electric potential difference is generated between electrodes each disposed in the upper and lower substrates.

21. The liquid crystal driving method according to claim 20, comprising:
performing the driving operation when the electric potential difference is generated between the electrode opposite to the liquid crystal layer side disposed in the one of the upper and lower substrates and an electrode disposed in the other of the upper and lower substrates.

22. The liquid crystal driving method according to claim 20, wherein the electrode disposed in the other of the upper and lower substrates is planar.

23. The liquid crystal driving method according to claim 14, wherein the electrode opposite to the liquid crystal layer side disposed in the one of the upper and lower substrates is planar.

24. The liquid crystal driving method according to claim 14, wherein the other of the upper and lower substrates includes a dielectric layer.

25. The liquid crystal driving method according to claim 14, wherein at least one of the upper and lower substrates includes a thin film transistor element, and
the thin film transistor element includes an oxide semiconductor.

26. A liquid crystal display device driven by the liquid crystal driving method according to claim 14.

27. The liquid crystal driving method according to claim 17, wherein the electrode opposite to the liquid crystal layer side is an electrode including a slit.

28. The liquid crystal driving method according to claim 27, wherein the one of the pair of the comb-shaped electrodes does not overlap the electrode including the slit or overlaps a part of the electrode including the slit in a plan view of the main faces of the substrates,
the other of the pair of the comb-shaped electrodes overlaps at least a part of the electrode including the slit in a plan view of the main faces of the substrates,
an overlapped region of the one of the pair of the comb-shaped electrodes and the electrode including the slit is smaller than an overlapped region of the other of the pair of the comb-shaped electrodes and the electrode including the slit, and
the liquid crystal driving method comprising:
performing a driving operation in which the one of the pair of the comb-shaped electrodes has a higher absolute value of an applied voltage than that of the other of the pair of the comb-shaped electrodes to align the alignment direction of the liquid crystal in a vertical direction or a horizontal direction to the main faces of the substrates.

29. The liquid crystal driving method according to claim 17, comprising:
performing the driving operation to align the alignment direction of the liquid crystal in a vertical direction to the main faces of the substrates when the electric potential difference is generated between electrodes each disposed in the upper and lower substrates.

30. The liquid crystal driving method according to claim 29, comprising:
performing the driving operation when the electric potential difference is generated between the electrode opposite to the liquid crystal layer side disposed in the one of the upper and lower substrates and an electrode disposed in the other of the upper and lower substrates.

31. The liquid crystal driving method according to claim 29, wherein the electrode disposed in the other of the upper and lower substrates is planar.

32. The liquid crystal driving method according to claim 17, wherein the electrode opposite to the liquid crystal layer side disposed in the one of the upper and lower substrates is planar.

33. The liquid crystal driving method according to claim 17, wherein the other of the upper and lower substrates includes a dielectric layer.
